(19) United States
(12) Patent Application Publication
(10) Pub. No.: US 2012/0282420 A1
(43) Pub. Date: Nov. 8, 2012

(54) DECORATIVE LAMINATION STRUCTURE, OUTER HOUSING STRUCTURE AND METHOD FOR MANUFACTURING OUTER HOUSING STRUCTURE

(75) Inventors: Kuang-Cheng FAN, Taipei City (TW); Yen-Jung CHEN, Taipei City (TW); Shih-Wei LI, Taipei City (TW); Hua-Lan LIN, Taipei City (TW)

(73) Assignee: COMPAL ELECTRONICS, INC., Taipei City (TW)

(21) Appl. No.: 13/175,945

(22) Filed: Jul. 4, 2011

(30) Foreign Application Priority Data
May 2, 2011 (TW) 100115371

(51) Int. Cl. B32B 1/02; B32B 38/14; B32B 38/10; B32B 3/00; B29C 45/14

(52) U.S. Cl. 428/35.7; 428/142; 264/279; 264/138; 156/701; 156/245

(57) ABSTRACT

An outer housing structure includes a soft polymer layer, a decorative layer and a plastic injection substrate. The soft polymer layer includes a three-dimensional texture surface. The decorative layer is disposed on a surface of the soft polymer layer, which is opposite to the three-dimensional texture surface. The plastic injection substrate is disposed the decorative layer, wherein the decorative layer is disposed between the soft polymer layer and the plastic injection substrate, and the plastic injection substrate and the decorative layer are bonded by a plastic injection process.

### RELATED APPLICATIONS

This application claims priority to Taiwan Application Serial Number 100115371, filed May 02, 2011 which is herein incorporated by reference.

### BACKGROUND

1. Field of Invention

The present invention relates to an outer housing structure of an electronic device and manufacturing method thereof.

2. Description of Related Art

A conventional way to form a soft layer on an outer housing of an electronic device is to coat a soft decorative layer on a preformed plastic or metallic housing of the electronic device. Such coating way hardly creates tactile senses and optical effects for the outer housing, and the coating would peel easily for a period of time.

Under the trend that the present electronic device desires an attractive appearance, more and more appearance designs and manufacturing method are needed for the outer housing structure. For the forgoing reasons, there is a need for inventive outer housing structure and manufacturing method to create extra tactile senses and optical effects.

### SUMMARY

It is therefore an objective of the present invention to provide an outer housing structure and manufacturing method thereof to create tactile senses and optical effects.

In accordance with the foregoing and other objectives of the present invention, a decorative lamination structure includes a removable transfer layer, a soft polymer layer and a decorative layer. The removable transfer layer includes a three-dimensional texture surface. The soft polymer layer has a first surface in contact with the three-dimensional texture surface, and the first surface is conformal to the three-dimensional texture surface. The decorative layer is disposed on an opposite second surface of the soft polymer layer.

According to an embodiment disclosed herein, the soft polymer layer has a shore hardness ranging from about 65 to about 100.

According to another embodiment disclosed herein, the removable transfer layer includes polycarbonate, polyethylene terephthalate, polypropylene or polyvinyl chloride.

According to another embodiment disclosed herein, the soft polymer layer includes thermoplastic polyurethanes, theroplastic vulcanizate or theroplastic styrene.

According to another embodiment disclosed herein, the decorative layer includes polyurethane, polymethylmethacrylate, epoxy, polycarbonate, polyethylene terephthalate, polypropylene, polyvinyl chloride, thermoplastic polyurethanes, theroplastic vulcanizate or theroplastic styrene.

In accordance with the foregoing and other objectives of the present invention, an outer housing structure includes a soft polymer layer, a decorative layer and a plastic injection substrate. The soft polymer layer includes a three-dimensional texture surface. The decorative layer is disposed on a surface of the soft polymer layer, which is opposite to the three-dimensional texture surface. The plastic injection substrate is disposed the decorative layer, wherein the decorative layer is disposed between the soft polymer layer and the plastic injection substrate, and the plastic injection substrate and the decorative layer are bonded by a plastic injection process.

According to an embodiment disclosed herein, the soft polymer layer has a shore hardness ranging from about 65 to about 100.

According to another embodiment disclosed herein, the soft polymer layer includes thermoplastic polyurethanes, theroplastic vulcanizate or theroplastic styrene.

According to another embodiment disclosed herein, the decorative layer includes polyurethane, polymethylmethacrylate, epoxy, polycarbonate, polyethylene terephthalate, polypropylene, polyvinyl chloride, thermoplastic polyurethanes, theroplastic vulcanizate or theroplastic styrene.

In accordance with the foregoing and other objectives of the present invention, a method for manufacturing an outer housing structure includes the steps of forming a removable transfer layer, which comprises a three-dimensional texture surface; forming a soft polymer layer on the three-dimensional texture surface and enabling a first surface of the soft polymer layer to be conformal to the three-dimensional texture surface; forming a decorative layer on an opposite second surface of the soft polymer layer such that the removable transfer layer, the soft polymer layer and the decorative layer collectively form a decorative lamination structure; and injecting a plastic substrate on the decorative layer.

According to an embodiment disclosed herein, the method further includes the step of preheating and cutting the decorative lamination structure to be put into an in-mould decoration mould.

According to another embodiment disclosed herein, the method further includes the step of removing the removable transfer layer from the decorative lamination structure to expose the first surface of the soft polymer layer.

According to another embodiment disclosed herein, the soft polymer layer and the removable transfer layer are bonded by a laminating process.

According to another embodiment disclosed herein, the decorative layer is formed on the opposite second surface of the soft polymer layer by a screen printing or roller printing process.

Thus, the outer housing structure herein is manufactured with a rubber-like soft surface and with three-dimensional texture so as to create tactile senses and optical effects. The soft polymer layer is attached to the removable transfer layer such that the three-dimensional texture can be transferred from the transfer layer to the soft polymer layer. The opposite surface of the soft polymer layer can be coated by a decorative layer. The decorative lamination structure is then put into an in-mould decoration mould for injecting a plastic injection substrate, and the removable transfer layer is removed to expose the soft polymer layer with the outmost three-dimensional texture surface.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1A illustrates a cross-sectional view of a decorative lamination structure according to one preferred embodiment of this invention;

FIG. 1B illustrates a cross-sectional view of an outer housing structure according to one preferred embodiment of this invention; and

FIG. 2 illustrates a manufacturing flowchart of the outer housing structure according to one preferred embodiment of this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

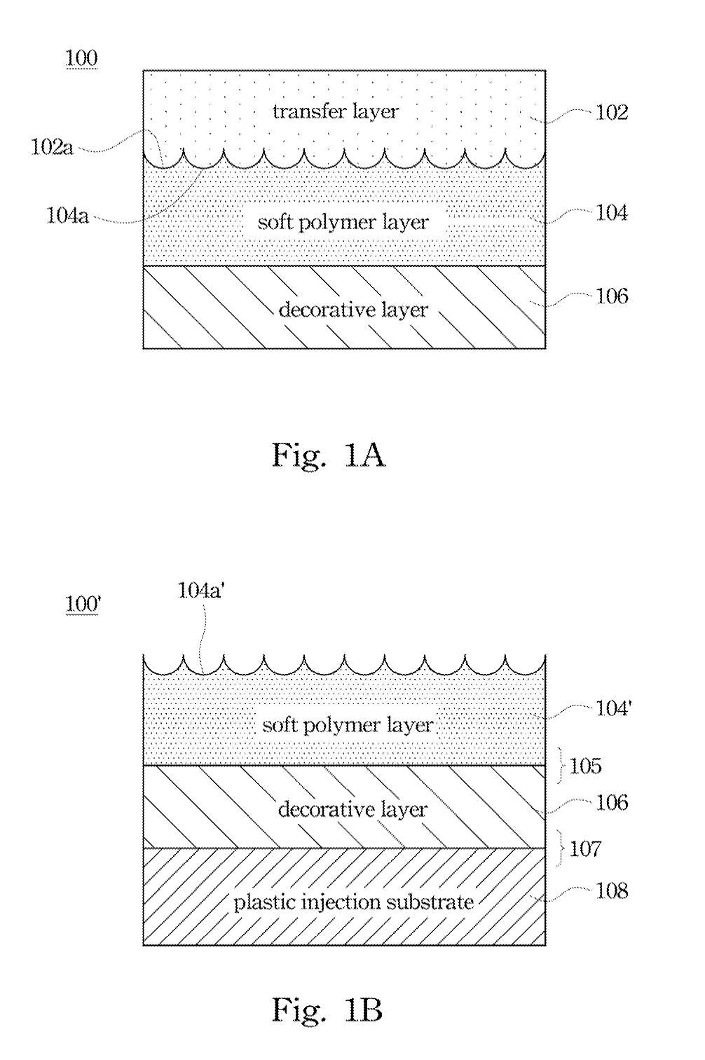

Referring FIG. 1A, which illustrates a cross-sectional view of a decorative lamination structure according to one preferred embodiment of this invention. The decorative lamination structure 100 includes a removable transfer layer 102, a soft polymer layer 104 and a decorative layer 106. The removable transfer layer 102 has a three-dimensional texture surface 102a. The pattern design on the three-dimensional texture surface 102a is not limited any specific design, but should create tactile senses and optical effects that ordinary persons can feel. The removable transfer layer 102 is used to transfer the pattern of its three-dimensional texture surface 102a to the soft polymer layer 104 such that a surface 104a of the soft polymer layer 104 can have the same pattern as the three-dimensional texture surface 102a after the removable transfer layer 102 is removed. In this embodiment, the soft polymer layer 104 has a shore hardness ranging from about 65 to about 100. Practically, the decorative lamination structure should include wear resistance tests (e.g. more than 300 times of 175 g tests), wool felt tests (e.g. more than 200000 times of 200 g tests), brightness tests (e.g. more than 90 degrees or not) and hardness tests (e.g. using 2H pencil press 500 g) to verify its quality. The decorative layer 106 provides the decorative lamination structure with colors, drawings or other decorative designs.

Referring to FIG. 1B, which illustrates a cross-sectional view of an outer housing structure according to one preferred embodiment of this invention. The outer housing structure 100′ is formed by adding a plastic injection substrate 108 on the decorative lamination structure 100 and removing the removable transfer layer 102 from thereof. When the surface 104a of the soft polymer layer 104 is formed in contact with the three-dimensional texture surface 102a, the surface 104a is conformal to the three-dimensional texture surface 102a. After the removable transfer layer 102 is removed, the surface 104a′ of the soft polymer layer 104 is equipped with the same pattern as the three-dimensional texture surface 102a. Besides, when the plastic injection substrate 108 is formed on the decorative layer 106 (by plastic injection process), the bonding interface 107 between the decorative layer 106 and plastic injection substrate 108 is thus strengthened, even the bonding interface 105 between soft polymer layer 104′ and decorative layer 106 is also strengthened. Therefore, the soft polymer layer 104 and decorative layer 106 can be firmly coated on the plastic injection substrate 108 and not easily removed or peeled.

In this embodiment, the removable transfer layer 102 can be, but not limited to, polycarbonate (PC), polyethylene terephthalate (PET), polypropylene (PP) or polyvinyl chloride (PVC).

In this embodiment, the soft polymer layer 104 can be, but not limited to, thermoplastic polyurethanes (TPU), theroplastic vulcanizate (TPV) or theroplastic styrene (TPS).

In this embodiment, the decorative layer 106 can be, but not limited to, polyurethane (PU), polymethylmethacrylate (PMMA), epoxy, polycarbonate (PC), polyethylene terephthalate (PET), polypropylene (PP), polyvinyl chloride, thermoplastic polyurethanes (TPU), theroplastic vulcanizate (TPV) or theroplastic styrene (TPS).

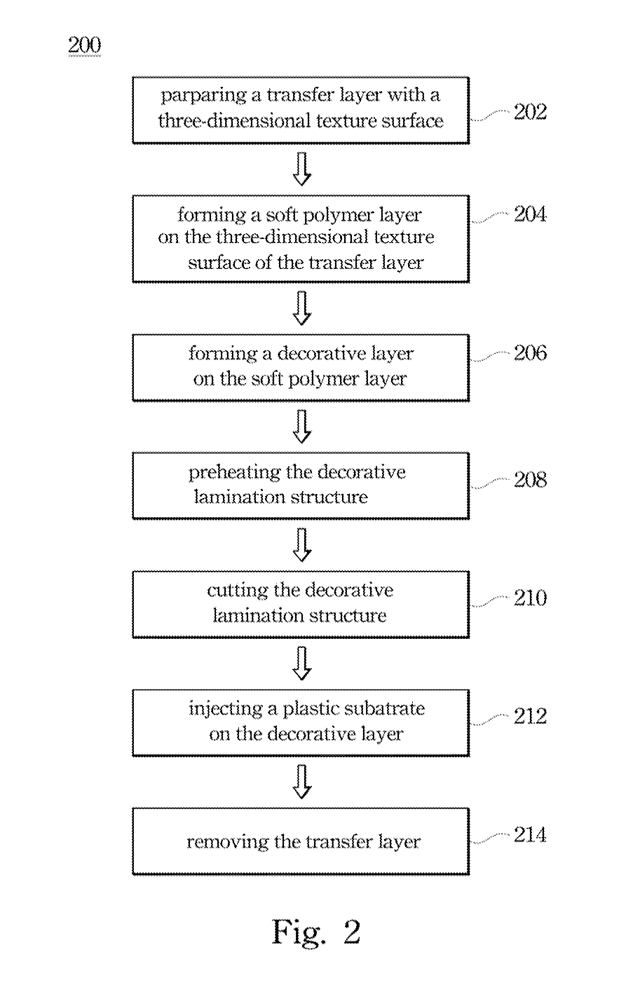

Referring to FIG. 2, which illustrates a manufacturing flowchart of the outer housing structure according to one preferred embodiment of this invention. The manufacturing method 200 is the method for manufacturing the decorative lamination structure 100 and outer housing structure 100′.

In step 202, a removable transfer layer (e.g. removable transfer layer 102) with a three-dimensional texture surface is prepared. The three-dimensional texture surface (e.g. three-dimensional texture surface 102a) is able to create tactile senses and optical effects that ordinary persons can feel.

In step 204, a soft polymer layer (e.g. soft polymer layer 104) is formed on the removable transfer layer (e.g. removable transfer layer 102) by a laminating process. A surface of the soft polymer layer is fully conformal to the three-dimensional texture surface of the removable transfer layer after the laminating process is applied.

In step 206, a decorative layer (e.g. decorative layer 106) is formed on an opposite surface of the soft polymer layer (e.g. soft polymer layer 104) by a screen printing or roller printing process such that the removable transfer layer, soft polymer layer and decorative layer collectively form a decorative lamination structure (e.g. decorative lamination structure 100).

In step 208 and step 210 (either one of these two steps can be performed first before the other), the decorative lamination structure is preheated and cut so as to be put into an in-mould decoration mould.

In step 212, after the decorative lamination structure is put into the in-mould decoration mould, a plastic injection is executed to form a plastic injection substrate (e.g. plastic injection substrate 108) on the decorative layer.

In step 214, the removable transfer layer is removed from decorative lamination structure to expose the soft polymer layer, and the three-dimensional texture surface's pattern has been transferred to the exposed surface of the soft polymer layer to serve as an outmost decorative surface of an outer housing.

According to the above-discussed embodiments, the outer housing structure herein is manufactured with a rubber-like soft surface and with three-dimensional texture so as to create tactile senses and optical effects. The soft polymer layer is attached to the removable transfer layer such that the three-dimensional texture can be transferred from the transfer layer to the soft polymer layer. The opposite surface of the soft polymer layer can be coated by a decorative layer. The decorative lamination structure is then put into an in-mould decoration mould for injecting a plastic injection substrate, and the removable transfer layer is removed to expose the soft polymer layer with the outmost three-dimensional texture surface.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A decorative lamination structure comprising:
a removable transfer layer comprising a three-dimensional texture surface;
a soft polymer layer comprising a first surface in contact with the three-dimensional texture surface, and the first surface is conformal to the three-dimensional texture surface; and
a decorative layer disposed on an opposite second surface of the soft polymer layer.

2. The decorative lamination structure of claim 1, wherein the soft polymer layer has a shore hardness ranging from about 65 to about 100.

3. The decorative lamination structure of claim 1, wherein the removable transfer layer comprises polycarbonate, polyethylene terephthalate, polypropylene or polyvinyl chloride.

4. The decorative lamination structure of claim 1, wherein the soft polymer layer comprises thermoplastic polyurethanes, theroplastic vulcanizate or theroplastic styrene.

5. The decorative lamination structure of claim 1, wherein the decorative layer comprises polyurethane, polymethylmethacrylate, epoxy, polycarbonate, polyethylene terephthalate, polypropylene, polyvinyl chloride, thermoplastic polyurethanes, theroplastic vulcanizate or theroplastic styrene.

6. A housing structure comprising:
a soft polymer layer comprising a three-dimensional texture surface;
a decorative layer disposed on a surface of the soft polymer layer, which is opposite to the three-dimensional texture surface; and
a plastic injection substrate disposed on the decorative layer, wherein the decorative layer is disposed between the soft polymer layer and the plastic injection substrate, and the plastic injection substrate and the decorative layer are bonded by a plastic injection process.

7. The housing structure of claim 6, wherein the soft polymer layer has a shore hardness ranging from about 65 to about 100.

8. The housing structure of claim 6, wherein the soft polymer layer comprises thermoplastic polyurethanes, theroplastic vulcanizate or theroplastic styrene.

9. The housing structure of claim 6, wherein the decorative layer comprises polyurethane, polymethylmethacrylate, epoxy, polycarbonate, polyethylene terephthalate, polypropylene, polyvinyl chloride, thermoplastic polyurethanes, theroplastic vulcanizate or theroplastic styrene.

10. A method for manufacturing a housing structure comprising:
forming a removable transfer layer, which comprises a three-dimensional texture surface;
forming a soft polymer layer on the three-dimensional texture surface and enabling a first surface of the soft polymer layer to be conformal to the three-dimensional texture surface;
forming a decorative layer on an opposite second surface of the soft polymer layer such that the removable transfer layer, the soft polymer layer and the decorative layer collectively form a decorative lamination structure; and
injecting a plastic substrate on the decorative layer.

11. The method of claim 10, further comprising:
preheating and cutting the decorative lamination structure to be put into an in-mould decoration mould.

12. The method of claim 10, further comprising:
removing the removable transfer layer from the decorative lamination structure to expose the first surface of the soft polymer layer.

13. The method of claim 10, wherein the soft polymer layer and the removable transfer layer are bonded by a laminating process.

14. The method of claim 10, wherein the decorative layer is formed on the opposite second surface of the soft polymer layer by a screen printing or roller printing process.
